(19) United States
(12) Patent Application Publication
(10) Pub. No.: US 2005/0100311 A1
(43) Pub. Date: May 12, 2005

(54) Method and system for recording video data

(76) Inventor: Thomas Hohenacker, Munich (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 10/468,664

(22) PCT Filed: Feb. 20, 2002
(86) PCT No.: PCT/EP02/01778

(30) Foreign Application Priority Data
Feb. 22, 2001 (EP) 01104317.1

(51) Int. Cl. H04N 5/76; H04N 5/781

(52) U.S. Cl. 386/46; 386/125

(57) ABSTRACT

The invention relates to a recording method whereby a communication link, preferably specifically in one venue, is established in at least one venue between a telephone, particularly the mobile telephone of a user, and a camera system installed in said venue. The video data is recorded by the camera system, whereby the user can have an interactive function. The invention also relates to a system for recording video data.

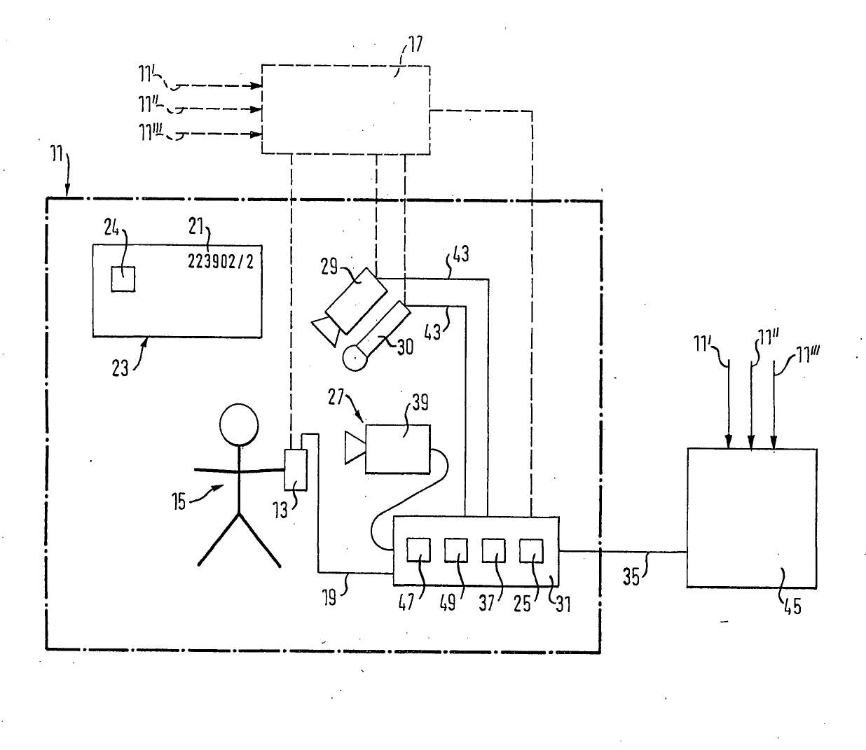

The invention relates to a method and to a system for the recording of video data at at least one venue (or scene), in particular at a plurality of venues (or scenes).

In particular in the field of television and of the Internet, there is a need for entertainment with individual and spontaneous elements and for possibilities to win over any desired people in a simple manner to participate in the most varied activities, with activities being particularly promising in which “the man or woman on the street” can participate and the viewer is thus entertained by people like him, i.e. by people with whom he can identify.

It is an object of the invention to provide a possibility, which can be realised in a simple manner, for the recording of video data with the participation of, basically, any desired persons.

This object is satisfied by the features of the independent method claim 1, and in particular in that a communication link and preferably a communication link specific to a venue or scene is set up at at least one venue or scene between a telephone, in particular a mobile telephone, of a user and a camera system installed at the venue or scene and video data are recorded by means of the camera system with a user as a participant.

Basically, any desired location in the world can be made into a stage for “the man or the woman on the street” with the invention. A publicly accessible location is preferably chosen as the venue or scene, e.g. a square or a street. Alternatively, in accordance with the invention, the venue can be located at a non-public location and be e.g. in a building. An admission fee can, for example, be charged for the access to the venue.

In accordance with the invention, the user himself can determine the time at which the video data are recorded in that the user sets up a communication link with e.g. his mobile telephone at a pre-determined scene to a camera system associated with the scene. In accordance with the invention, the participant thus initiates the recording of personal video data himself on a voluntary basis by telephone.

The invention advantageously uses an infrastructure present at the scene with the telephone and, in the case of a mobile telephone, an infrastructure present with the user.

The video data can be presentations or show acts of the user, e.g. the singing of a song, pantomime presentations or spoken or sung greetings to friends and acquaintances. Furthermore, the user can be prompted to answer quiz questions. The user can further use the invention to present himself to a wide public, whereby e.g. singles shows can be realised. On the other hand, the invention can be used for the carrying out of polls. Furthermore, recruitment activities can be carried out by means of the invention. The invention can in particular be used for casting purposes.

In accordance with the invention, the loudspeaker of the telephone can be used for direct communication with the user, which is in particular of advantage if, e.g. with quiz games, the communication should take place to the exclusion of surrounding people who should e.g. not hear the quiz questions asked.

In a particularly preferred embodiment of the invention, the camera system is called by the telephone over a telephone number specific to the scene to set up the communication link. The user at the scene e.g. dials the telephone number specific to the scene using his mobile telephone to set up the communication link. The telephone number can generally be any desired one and can e.g. be a normal mobile radio network number or a toll number.

Provision is furthermore preferably made for at least a telephone number specific to the scene to be displayed at a display device installed at the scene.

In this manner, a normal advertising area can be made into an interactive display device whose installation location can be made into a recording studio by anyone simply by calling the telephone number displayed.

In accordance with the invention, either precisely one telephone number can be associated with the scene or a plurality of telephone numbers specific to the scene can be provided which make a selection possible for the user from e.g. different categories such as “singles show”, “quiz game”, “casting” and “poll”.

In addition to the telephone number or telephone numbers, instructions can be displayed which explain the purpose which the telephone numbers serve to the viewer located at the scene. This information can, for example, be displayed in an advertising environment.

The display device can e.g. be a placard, a poster or a monitor.

The display device is preferably used as the background during the recording. During the recording, the user e.g. stands in front of a display device, e.g. a placard wall such as is customarily used for advertising purposes, which is designed as a recording background. For example, known television studios can be reproduced in a square or in a street with the invention by a corresponding design of the display device and selection of the recording conditions.

It is further provided in accordance with the invention for an ongoing recording to be displayed visually and/or acoustically at the scene. Such an “on air” display preferably takes place on a display device showing the telephone number(s) specific to the scene and serving as the recording background. A placard wall e.g. thus satisfies an effective additional function. The “on air” display can e.g. take place by a red light and/or by the wording “on air” lighting up during the recording, whereby a genuine studio atmosphere arises at the scene. The display unit installed at the scene creates a particular attraction for the user since he cannot only personally transform the scene into his own studio by initiating a recording by telephone, but can also direct the attention of persons at the scene to the recording activity and thus to his person with the aid of the additional visual and/or acoustic display. The display unit does not have to be integrated e.g. into a placard wall displaying the telephone number and serving as the recording background and can generally be arranged at any desired position at the scene.

It is furthermore proposed in accordance with the invention that audio data can be picked up, and in particular stored, over the telephone. The sound, in particular the language, of the user for the video data can thus be picked up and, optionally, recorded for later use, without additional technical recording effort utilising the infrastructure present at the scene or with the user.

Alternatively or additionally, audio data can be recorded via a sound recording system installed at the scene. Surrounding sound can hereby be picked up and thus the atmosphere of the scene be captured.

It is furthermore preferably provided that the camera system operates automatically, and in particular in accordance with an at least substantially pre-settable recording procedure, preferably influenceable over the telephone.

It is preferred for the camera system to be activated, deactivated and/or controlled via a recording unit and/or over the telephone.

The camera system is preferably both switched on and also switched off again after the termination of the recording by means of the telephone. Everyone can thus more or less become his own studio manager. In the case of a permanently running camera system, an additional procedure is started and ended by means of the telephone which in particular includes a transmission and/or recording of the data provided by the camera system not taking place outside the periods started and ended by the user.

The activation and deactivation of the camera system or of the additional procedures takes place either directly between the telephone and the camera system or via an intermediate station e.g. in the form of a recording unit located at the scene or of a recording centre spatially separated from the scene.

A recording unit is preferably provided which is made for communication with the telephone and with the camera system and in particular for the controlling of the camera system. The communication between the telephone and the camera system can hereby be set up via the recording unit.

The recording unit is preferably installed at the scene and is in particular arranged in spatial proximity to the camera system, preferably integrated into the camera system.

The recording unit can include a communication unit, in particular in the form of a speech computer, for the communication with the user. Voice messages, in particular information, instructions, explanations and/or direction instructions, can be transmitted to the user over the telephone using the communication unit. The communication with the user preferably takes place with menu control, with the user being able to be guided through a menu, for example, with the help of the keypad of his mobile telephone.

The user can be guided directly by means of the voice messages and can, for example, be prompted to look into a camera which is installed, preferably in a hidden or camouflaged manner, at the scene in order to be protected from vandalism. Furthermore, game rules can be explained to the user, the user can be informed of any legal conditions which may apply and the user can be advised of the start and of the end of the actual recording.

Alternatively or additionally to a communication unit, voice messages can be transmitted to the user at least in part by a person acting as a studio manager, as a host or as a director who e.g. is located at a recording centre to which the user has previously set up a communication link.

In accordance with a further preferred embodiment of the invention, in particular user data specific to the user and/or relating to the respective recording are transmitted to a recording unit, and in particular stored, over the telephone, with the keypad of the telephone preferably being used for the inputting of the data.

The user hereby advantageously himself ensures that user data are collected which are e.g. required for the respective recording or for a later evaluation. The participants can thus fill a central database with their personal data themselves on a voluntary basis. The user data are for example user-specific information such as sex and age or data which relate to the respective recording. The user can thus, e.g. in the framework of a quiz game or of a poll, choose between different answers to a question in that he presses a respectively corresponding key on the telephone.

It is furthermore preferably provided in accordance with the invention for a distinction to be made by means of stored user data and/or pre-determinable criteria between at least temporarily blocked users, on the one hand, and users to be accepted, on the other hand.

The stored user data cannot only be the aforesaid data, but also e.g. the telephone number of the telephone used by the user to be called. This opens up the possibility e.g. of blocking specific mobile telephones directly and so of excluding their owners from taking part. The recording system can thereby be protected from troublemakers. In addition to this protection from vandalism, such calling users can moreover be identified who satisfy specific pre-settable selection criteria. If e.g. the telephone numbers of the callers are recorded with the respective time, then it can be ensured with the help of these data that every user is only accepted once within a pre-settable time of, for example, one day or one week. The functionality of the system is also ensured hereby. Furthermore, the stored user data can also be used for competitions in that e.g. the calls of the users are counted and the reaching of a specific number of calls is rewarded.

As a result, the system security can be increased, the functionality of the system ensured and a plurality of additional use variants can be provided simultaneously by the storage of user data.

The recording unit can include a control unit, in particular a computer supported control unit, for the communication with the camera system. Provision can alternatively or additionally be made for the camera system to be remote controlled e.g. by a recording centre spatially separated from the scene. This can likewise take place automatically by means of a control unit or manually by a person located at the recording centre.

In accordance with a further preferred embodiment of the invention, a memory unit is provided, e.g. in the form of a computer hard disk, for the storage of recording data including at least the video data. The memory device is preferably installed at the scene and is in particular integrated into the camera system or into a recording unit, with the recording data in particular being stored in a database. Generally, video data can also be recorded on magnetic tapes such as conventional videocassettes.

In a further variant of the invention, it is proposed that the recording unit is designed as an Internet server. Recording data which include at least the recorded video data can thus be stored at the scene and can be activated over the Internet.

In accordance with a further preferred embodiment of the invention, technical recording equipment installed at the scene can be activated, deactivated and/or controlled subsequent to the setting up of the communication link, in particular via a recording unit and/or over the telephone. The technical recording equipment is, for example, lighting and/or sound recording equipment.

This user-initiated operation of the recording equipment is in particular of advantage when a building, e.g. a restaurant, a discotheque, a cinema or an event hall, is used as the scene. The scene can be a part of the building made as a stage.

In particular when the scene is a building or a building part, a telephone installed at the scene can be provided for the communication. Mobile telephones of the users can then be dispensed with.

Provision is further made in accordance with the invention for recording data including at least the video data, in particular stored at the scene, to be able to be transmitted to a location spatially separated from the scene via a communication network or a data network. For this purpose, e.g. a recording unit of the camera system is simply connected to a local telephone network e.g. via an ISDN, ADSL, HDSL, TDSL or analogue connection.

It is generally also possible in accordance with the invention to transmit the recorded data over a wireless communications network, in particular over a mobile radio network, from a transmitter unit located at the scene to a receiver unit spatially separated from the scene and e.g. located at a recording centre.

In a variant of the invention, the recording data can be transmitted to an Internet server in order to make the recording data available on the Internet in this manner.

It is also possible for the recording data to be transmitted to a recording centre spatially separated from the scene. The video data can here be subjected e.g. to a later processing and can in particular be put together, preferably synchronised, with picked-up audio data.

Generally, any suitable data transmission method can be used for the transmission.

In a further variant of the invention, provision is made for recording data at least including the video data to be broadcast on television.

In this connection, the recordings can each form a programme part which includes e.g. a show act or a presentation under the participation of the calling user. A television programme can be put together from a plurality of recorded programme parts. The invention hereby makes it possible to collect programme pieces recorded during a recording period, e.g. during one day, at one or more scenes and to compile a television programme according to specific selection criteria from the collected programme pieces which is broadcast, for example, daily in the evening.

This television programme can have a great variety with a minimum of production costs and show e.g. a singing Chinese person, a South African woman answering quiz questions, a single Swede looking for a partner and an exchange student living in the US who is greeting her parents in Germany in a single show, and indeed in each case at original scenes and without the use of labour intensive and cost intensive recording teams.

The recorded programme parts can be subjected to a later processing. The programme parts can in particular be cut as required, be provided with a commentary and/or have a music soundtrack added.

It is also alternatively or additionally possible in accordance with the invention to make the recording data available on the Internet. Recordings prepared e.g. in the framework of quiz shows, singles shows or other entertainment activities can thus be called up by everyone, and indeed either free of charge or at a charge. The recordings can also be used, however, for purely non-public purposes e.g. within a framework of recruitment, casting or poll activities, with provision being able to be made for only authorised persons to have access to the stored recording data.

Furthermore, the camera system can be used in the manner of a so-called web cam, in that a live recording of the scene is made available at times or at least substantially without interruption on the Internet by means of the camera system. The user can ensure that, by means of the telephone, recording sections which can be defined by him with respect to the starting point and the end point and in which he is himself recorded are stored. The user can thus e.g. immortalise himself on the Internet, since the stored recorded sections, unlike the live transmission, are not lost.

In accordance with a particularly preferred embodiment of the invention, provision is made that video data are recorded at a plurality of spatially separated scenes.

In accordance with the invention, a network of scenes and camera systems spanning the world can generally be used, with only a power supply and a connection possibility to a communication network or a data network, for which a normal telephone line is sufficient, having to be present for the camera systems at the respective scene. Spontaneous and individual presentations or other recordings can hereby be collected with participants from all over the world.

A variety of further application possibilities arises due to the use of a plurality of spatially separated camera systems. For instance, rally games an e.g. be carried out with the invention in which the participants have to successively visit a plurality of scenes in accordance with a predetermined procedure and e.g. to perform specific tasks there. The rally can, for example, be watched by everyone via television and/or via the Internet live or e.g. as part of subsequently produced reports.

The distribution of the scenes is preferably limited to a city, to a region or to a country.

Provision is made in accordance with the invention for the setting up of the communication link being prevented in each case outside a limited zone containing the respective scene, but no further scenes. A recording specific to the scene is hereby guaranteed and it is ensured that disturbances by such persons who call up from outside the respective zone under a telephone number associated solely with the respective scene are prevented. The limited zone is in particular a mobile radio cell covering the scene.

The satisfaction of the object underlying the invention also takes place by the features of the independent apparatus claim and in particular takes place by a system for the recording of video data at at least one scene with at least one camera system installed at the scene to which a communication link can be set up, which is preferably specific to the scene, using a telephone located at the scene, in particular a mobile telephone of a user and which can be operated, when the communication link has been established, for the recording of video data with the user as a participant.

Only a camera system thus has to be made available for each scene by an operator of the system. The further infrastructure is already present when the mobile telephones of the users and the respective mobile radio networks are used or a telephone present at the scene is used. Otherwise only a telephone has to be made available at the scene.

Further preferred embodiments of both the recording method in accordance with the invention and of the recording system are set forth in the dependent claims, in the description and in the drawing.

The invention will be described in the following by way of example with reference to the drawing whose only FIGURE shows a schematic representation of an embodiment of a recording system which is suitable for the carrying out of the recording method in accordance with the invention.

In the variant of the invention shown, the recordings take place at a variety of individual venues or scenes 11 of which one is shown in the FIGURE by a chain-dotted line. Further scenes 11′, 11″, 11′″, etc. are indicated in the FIGURE by arrows directed to an Internet server 45 and to a recording centre 17 which will be described in more detail at another point.

The scene 11 is a publicly accessible location, for example a square or part of a street in a town. Non-public scenes and scenes e.g. requiring an entrance fee can generally also be considered. The scene 11 can also be located in the interior of a building. A part of a building designed as a stage can, e.g., serve as the venue 11.

A display device 23 is installed, e.g. in the form of a placard wall usually used for advertising purposes, at the scene 11. A telephone number 21, e.g. of a mobile radio network, which is associated exclusively with the respective scene 11, is displayed on the display device 23. Furthermore, a display unit 24, e.g. in the form of a red lamp or of an illuminated message “on air”, is integrated in the display device 23 and can be controlled via a recording unit 31 described in more detail in the following in order to visually display an on-going recording.

The recording system furthermore includes a camera system 27 installed at the scene 11 which has a camera 39 and a computer controlled recording unit 31 connected to the camera 39 arranged in spatial proximity to the camera 39. The recording unit 31 includes a computer aided control unit 47 for the camera 39, an evaluation unit 37 e.g. in the form of a computer hard disk for the storage in particular of recording data and user data as well as a communication unit 25 in the form of a speech computer for the communication with a user 15.

The camera system 27 is positioned such that the camera 39 can view the whole scene 11, or at least a part thereof, on the one hand, and the camera system 27 is protected as much as possible from vandalism, on the other hand. For this purpose, the camera system 27 can be located, for example, in an apartment from where there is a good view of the scene 11. The camera system 27, in particular the camera 39, is preferably positioned in a hidden or camouflaged manner such that uninitiated persons cannot discover the location of the camera 39.

The recording system moreover utilises mobile telephones 13 of users 15 located at the scene 11 as well as the respective mobile radio networks for the carrying out of the recording method in accordance with the invention.

Generally, a telephone installed at the scene 11 can also be used. Mobile telephones 13 can then be dispensed with.

Any person 15 with a mobile telephone 13 who is located at the scene 11 can have themselves recorded by means of the camera system 27. For this purpose, the user 15 dials the telephone number 21 specific to the scene and displayed on the display unit 23 with his mobile telephone 13.

In a preferred variant of the invention, a communication link 19 is hereby set up between the mobile telephone 13 and the local recording unit 31.

In accordance with an alternative, which is indicated by broken lines in the FIGURE, the communication between a telephone 13 and the camera system 27 can also take place via a recording centre 17 which can be located at any desired place in the world and which can communicate with the camera system 27 via generally any desired communication network or data network, e.g. a normal telephone network. The functions of the recording unit 31 can also be carried out in full or in part by the recording centre 17 so that, in this respect, the recording centre 17 will not be dealt with in any more detail in the following.

The recording system furthermore includes an Internet server 45 to which recorded data, in particular video data fed into the recording unit 31 via the camera 39, can be transmitted. The communication between the recording unit 31 and the Internet server 45 spatially separated from the scene 11 takes place via a normal telephone network 35. For this purpose, the recording unit 31 is connected, e.g. via a local ISDN connection at the scene 11, to the telephone network 35. Generally other communication networks and basically also wireless communication networks can be used for the data transmission. The Internet server 45 can be located at any desired location in the world.

Irrespective of whether a recording centre 17, which may be present, is used for the control of the procedures at the scene 11 or not, recorded data can alternatively or additionally also be transmitted from the scene 11 to the recording centre 17, where the data can be prepared, processed later and compiled in a suitable manner into a programme, e.g. for a television broadcast, or can be evaluated in another manner and for other purposes.

It is also possible in accordance with the invention that the recording unit 31 is itself made as an Internet server. Recorded and stored data can then be called up directly at the recording unit 31.

The recording system furthermore includes technical recording equipment, and indeed lighting equipment 29 as well as a sound recording system 30. This recording equipment 29, 30, which is in particular used at a location 11 located in a building, can be activated, deactivated and controlled via the control unit, and indeed via corresponding communication networks 43 which are made, for example, as simple control lines.

Audio data picked up both with the sound recording system 30 and via the microphones of the mobile telephones 13 can be stored together with video data delivered by the camera 39 in corresponding databases of the memory device 37. Moreover, pre-set selection data as well as user data can be stored in the recording unit 31. Said user data include in particular telephone numbers of telephones 13 of calling users 15 as well as data input by the users 15 themselves over the telephones 13, in particular over the telephone keypads.

The manner of operation of the system is as follows, for example:

A user 15 at the scene 11 dials with his mobile telephone 13 the telephone number 21 which is displayed on the placard wall 23 reproducing the studio of a known television show.

An automatic check is made in the recording unit 31 with the help of the evaluation unit 49 with reference to stored telephone numbers whether the caller 15 is accepted. This is e.g. not the case if more than three calls have already been made with the telephone 13 on the same day, or more than ten calls within the last week. Persons calling from outside the mobile radio cell covering the scene 11 can also be excluded by applying corresponding selection criteria.

The communication between the called camera system 2 and both blocked and accepted users 15 takes place through the speech computer 25 of the recording unit 31. If the recording centre 17 is used, then a person working as a studio manager, a host or as a director in the recording centre 17 can also talk to the user 15.

The user 15 can, for example, thus be informed that he has the opportunity of a presentation, for example, to sing a song, to answer quiz questions, to introduce himself in the framework of a singles show or to take part in a poll and will thereby be recorded by a camera 39. In the case of recruitment, casting or poll activities, the user 15 can be advised of what is expected of him within the framework of the respective activity.

If the user 15 is not aware of the existence and/or the location of the camera 39, the user 15 can also be instructed via his mobile telephone 13 to turn in a specific direction to be covered by the camera 39. Moreover, the user 15 can be directed to a specific position, for example a marked position, at the scene 11 via his mobile telephone 13.

To satisfy any existing legal requirements or other provisions, the user 15 can moreover be informed of the respective legal background before the start of a recording. The user 15 can in particular be asked to declare his agreement to his being recorded and, optionally, to the recording being made accessible to the public and/or used commercially.

During this preparation phase, the user 15 can be led through a menu by the recording unit 31 in which he can select from proposed menu items via speech control or via the keypad of his telephone 13.

The user 15 can also be prompted to transmit specific data such as his sex, his age, his occupation, etc. to the recording unit 31 via the keypad of his telephone 13 in order to fill a database of the memory device 37. Any desired information can be translated into keypad inputs in this manner and stored in digital form.

The input of information or data either by speech or via the telephone keypad is not limited to the preparation for the recording, but can also take place during the actual recording.

The “on air” or “transmitting” display 24 is already activated automatically by the recording unit 31 directly subsequently to the setting up of the communication link 19 or at the start of the actual recording, whereby a forthcoming or ongoing recording is displayed to persons located at the scene 11.

Moreover, the recording equipment 29, 39 is automatically activated by the recording unit 31 to provide an optimum lighting and to pick up surrounding sound. It can also be made possible for the user 15 to himself operate the recording equipment 29, 30 installed at the scene 11 and the camera system 37, at least within certain limits, via his telephone 13.

The recording system is conceived such that, during the actual recording, the user 15 stands in front of the placard wall 23 which thus forms the recording background. The user 15 can immerse himself in the scenario pre-determined by the design of the placard wall 23, that is more less “beam” himself into the scenario, simply by calling the telephone number 21 specific to the scene.

The start and end of the actual recording can likewise be advised to the user over his telephone 13.

Video data recorded with the camera 37 during the recording, audio data picked up with the sound recording system 30 and the telephone 13, user data transmitted via the keypad of the telephone 30 and the telephone numbers of the telephones 13 uses for calls are stored in databases of the memory device 37.

These recording data can be transmitted to the Internet server 45 and/or to the optionally present recording centre 17 directly subsequent to the recording via the telephone network 35 or called up at a later time.

The recording unit 31 can be fitted with a preview function which makes it possible at least for authorised persons to view the stored video data comparatively fast with reduced image quality from any desired location.

The putting together, in particular the synchronisation of image and sound can take place by suitable processes in the recording unit 31, at the. Internet server 45 or in the optionally present recording centre 17.

Whereas data recorded for entertainment purposes will be made publicly accessible on the Internet or broadcast on television at no charge or at a fee, data obtained e.g. within the framework of poll, recruitment or casting activities can only be accessed by authorised persons, e.g. the respective principal.

A programme can be compiled and broadcast at a later time from a plurality of recordings collected for television in the form e.g. of individual programme parts which were recorded during a recording period covering, for example, one or more days at a scene 11 or at a plurality of scenes 11, 11′, 11″, 11′″, etc.

1. Recording method in which
a communication link, in particular a communication link specific to a venue or scene, is set up at at least one venue or scene between a telephone, in particular a mobile telephone of a user and a camera system installed at the scene and
video data are recorded by means of the camera system with a user as a participant.

2. Method in accordance with claim 1, wherein the camera system is called via a telephone number specific to the scene by means of the telephone for the setting up of the communication link.

3. Method in accordance with claim 1 wherein at least one, preferably precisely one, telephone number specific to the scene is displayed on a display device, in particular a placard, a poster or a monitor, installed at the scene with the display device in particular being used as a background during the recording.

4. Method in accordance with claim 1, wherein a running recording at the scene is displayed visually and/or acoustically, in particular on a display device.

5. Method in accordance with claim 1, wherein audio data is picked up, and in particular stored, via the telephone and/or in that audio data is picked up, and in particular stored, via a sound recording system installed at the scene.

6. Method in accordance with claim 1, wherein the camera system operates automatically and in particular in accordance with an at least substantially pre-settable recording procedure which can preferably be influenced via the telephone and/or wherein the camera system is activated, deactivated and/or controlled via a recording unit and/or via the telephone.

7. Method in accordance with claim 1, wherein the communication link is set up between the telephone and a recording unit serving for the communication with the camera system and in particular for the control of the camera system.

8. Method in accordance with claim 1, wherein technical recording equipment, in particular for the lighting and/or sound recording, installed at the scene is activated, deactivated and/or controlled subsequent to the setting up of the communication link, in particular via a recording unit and/or via the telephone.

9. Method in accordance with claim 1, wherein a communications unit, in particular in the form of a speech computer, is used for the communication with the user and/or in that voice messages, in particular information, instructions, explanations and/or direction instructions, are preferably communicated to the user via the telephone by menu control.

10. Method in accordance with claim 1, wherein user data, in particular relating to the specific user and/or to the respective recording, are communicated to a recording unit, and in particular stored, via the telephone, in particular via a keypad of the telephone and/or in that a distinction is made by means of stored user data and/or pre-settable criteria between at least temporarily blocked users, on the one hand, and users who are to be accepted and who preferably satisfy pre-settable selection criteria, on the other hand.

11. Method in accordance with claim 1, wherein at least the recorded data including the video data is preferably stored at the scene and/or wherein the recorded data at least including the video data, and in particular recording data stored at the scene, is transmitted via a communication network or a data network, in particular via an existing telephone network, to a place which is preferably spatially separated from the scene, in particular to an Internet server or to a central recording facility and/or wherein the recorded data at least including the video data is broadcast on television and/or made available on the Internet.

12. Method in accordance with claim 1, wherein a live recording of the scene is made available, in particular on the Internet, at times or at least substantially without interruption, by means of the camera system, with definable recording sections with respect to the time of starting and of ending being stored by means of the telephone.

13. Method in accordance with claim 1, wherein the video data is subjected to later processing and is in particular combined with recorded audio data, preferably synchronised.

14. Method in accordance with claim 1, wherein video data are recorded at a plurality of spatially separated scenes and/or wherein the setting up of a communication link is prevented outside of a restricted region containing the respective scene, but no further scene.

15. Method in accordance with claim 1, wherein a publicly accessible place is selected as a scene, in particular a square or a street; and/or in that a building is selected as the scene, in particular a restaurant, a discotheque, a cinema or an event hall, preferably a building part designed as a stage.

16. System for the recording of video data at at least one scene, in particular for carrying out the method of claim 1, having at least one camera system installed at the scene to which a communication link preferably a scene-specific communication link can be set up with a telephone located at the scene, in particular a mobile telephone of a user and can be operated with an established communication link for the recording of video data with the user as participant.

17. System in accordance with claim 16, wherein
the camera system can be called up by means of the telephone via at least one telephone number specific to the scene.

18. System in accordance with claim 16, wherein
at least one display device is provided which is installed at the scene on which at least one and preferably precisely one telephone number specific to the scene is displayed or can be displayed, with a placard, a poster or a monitor in particular being provided as the display device and/or in that the display device is formed as a recording background.

19. System in accordance with claim 16, wherein
a display unit installed at the scene is provided with which a running recording can be indicated optically and/or acoustically, in particular in the form of a coloured light signal and/or an illuminated written display, with the display unit preferably being integrated into a device for displaying at least one telephone number specific to the scene.

20. System in accordance with claim 16, wherein
audio data transmitted via the telephone of the user can be recorded, and in particular stored, and/or in that a sound recording system installed at the scene is provided for the recording of in particular storable audio data.

21. System in accordance with claim 16, wherein
the camera system is automatically operatable and in particular in accordance with an at least substantially pre-determinable recording procedure, which can preferably be influenced via the telephone.

22. System in accordance with claim 16, wherein
a recording unit is provided which is designed for communication with the telephone and with the camera system, and in particular for the control of the camera system, with the recording unit in particular being installed at the scene and in particular being arranged in the spatial vicinity of the camera system and preferably being integrated into the camera system.

23. System in accordance with claim 22, wherein
the recording unit includes a communication unit, in particular in the form of a speech computer, for the communication with the user, with speech messages, in particular information, instructions, explanations, and/or direction explanations being conveyable to the user, preferably under menu control, in particular by means of the communication unit via the telephone.

24. System in accordance with claim 22, wherein
the recording unit comprises a control unit, in particular a computer-controlled control unit, for the communication with the camera system.

25. System in accordance with claim 16, wherein
user data, in particular user specific data and/or data relating to the respective recording, can be conveyed to a recording unit and are is in particular storable via the telephone, in particular via a keyboard of the telephone and/or wherein an evaluation unit is provided which is designed to distinguish between at least temporarily blocked users on the one hand and users which are to be allowed and which preferably satisfy pre-determinable selection criteria on the other hand, by comparison of transmitted user data of calling users with stored user data and/or pre-determinable criteria, with the evaluation unit preferably being integrated into the recording unit.

26. System in accordance with claim 16, wherein
a storage device is provided for the storage of recording data including at least the video data, in particular in a databank, with the storage device preferably being installed at the scene and in particular being integrated into the camera system or into a recording unit.

27. System in accordance with claim 16, wherein
the recording data including at least the video data and in particular the recording data stored at the scene can be transmitted via a communication network or data network, in particular via an existing telephone network, to a location spatially separate from the scene, with the recording data in particular being transmittable to an internet server spatially separate from the scene and/or wherein the recording data can be transmitted to a recording center spatially separated from the scene.

28. System in accordance with claim 16, wherein
video data stored in particular in a recording unit and/or on an internet server can be called up in reduced image quality for preview and/or selection purposes.

29. System in accordance with claim 16, wherein
a plurality of camera systems are provided which are associated with various scenes and/or in that a common recording center is associated with a plurality of spatially separated scenes.
